(19) United States
(12) Patent Application Publication
(10) Pub. No.: US 2013/0002758 A1
(43) Pub. Date: Jan. 3, 2013

(54) Fastening Apparatus and Method Thereof

(76) Inventor: Alon Navon, Azour (IL)

(21) Appl. No.: 13/171,830

(22) Filed: Jun. 29, 2011

(51) Int. Cl. B41J 23/00; B23P 11/00; F16B 35/04

(52) U.S. Cl. 347/37; 411/419; 29/890.1

(57) ABSTRACT

A fastening apparatus useable with a receiving member. The fastening apparatus includes a fastener body with a plurality of deflection members spaced apart from each other. The fastener body including an initial state corresponding to the plurality of deflection members spaced apart from each other by a first distance and a deflection state corresponding to the plurality of deflection members spaced apart from each other by a second distance less than the first distance. Each of the plurality of deflection members including a deflection threaded portion to engage with the receiving threaded portion of the receiving member in an engagement state. During insertion, the fastener body moves between the initial state and the deflection state such that the deflection threaded portions insert into the receiving threaded portion to form the engagement state.

### BACKGROUND

Fastening apparatuses, such as fasteners, are useable with receiving members. Fastening apparatuses may provide temporary and/or permanent connection between a fastener and one or more objects, such as a receiving member.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a fastening apparatus according to an example;

FIG. 2 illustrates a schematic diagram of a fastening apparatus according to an example;

FIG. 3 illustrates a block diagram of a mounting system according to an example;

FIG. 4 illustrates a schematic diagram of a mounting system according to an example;

FIG. 5 illustrates a cross-sectional view of a portion of the mounting system of FIG. 4 according to an example; and

FIG. 6 illustrates a flow chart of a method to mount a printhead according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

Printheads may be used in a variety of printing techniques. For example, inkjet printheads having a matrix of inkjet nozzles that selectively eject ink droplets are used in computer printers and large format graphics printers. Printheads may be assembled in, for example, one or two dimensional arrays on carriages to achieve a higher print throughput and higher print resolution. Printheads mechanically interface with the carriage using fasteners, such as bolts that screw into the carriage using a torque wrench, to couple the printheads to the carriage. However, replacement of fasteners may not be easy as the assembly may include tight areas that make it difficult to use a torque wrench.

In examples, a fastening apparatus useable with a receiving member is provided. The apparatus includes, among other things a fastener body with a plurality of deflection members spaced apart from each other. Each of the plurality of deflection members include a deflection threaded portion to engage with the receiving threaded portion of the receiving member in an engagement state such that the fastener body moves between a first distance and second distance less than the first distance during insertion and reaches an engagement state. The fastener body may be inserted into an engagement state without use of a torque wrench, but with a smaller tool, such as a plunger hammer.

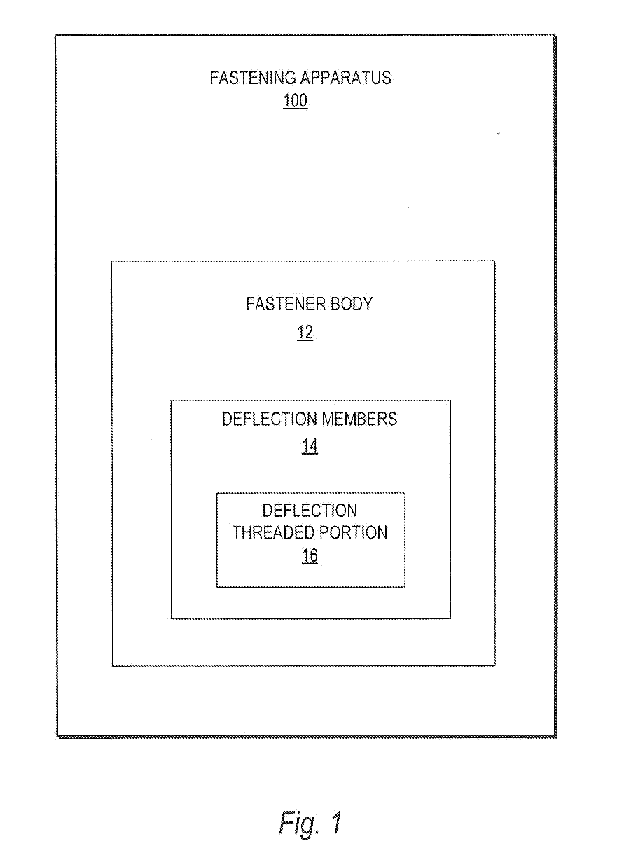

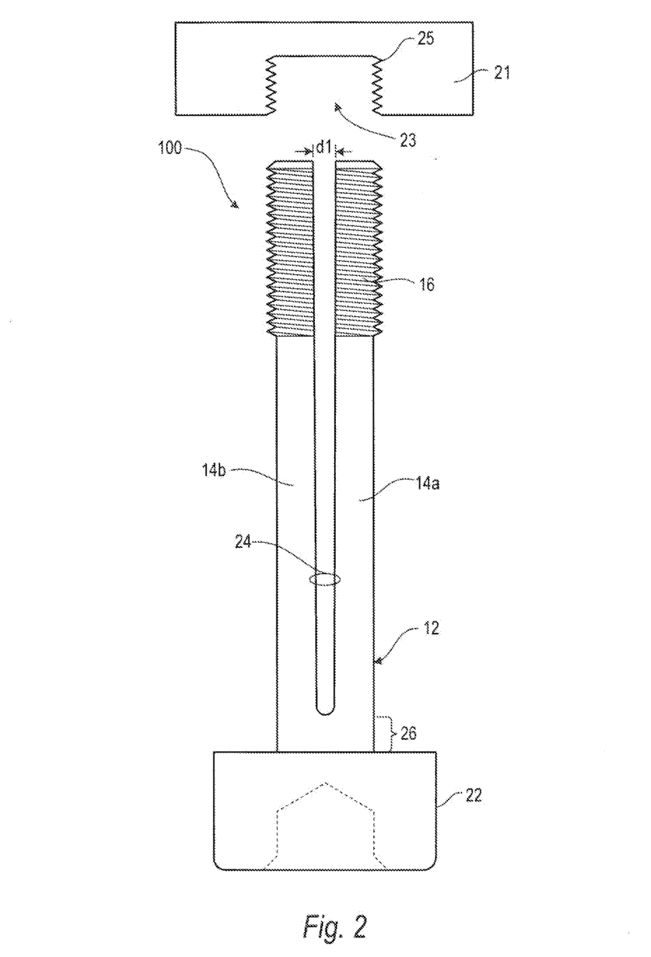

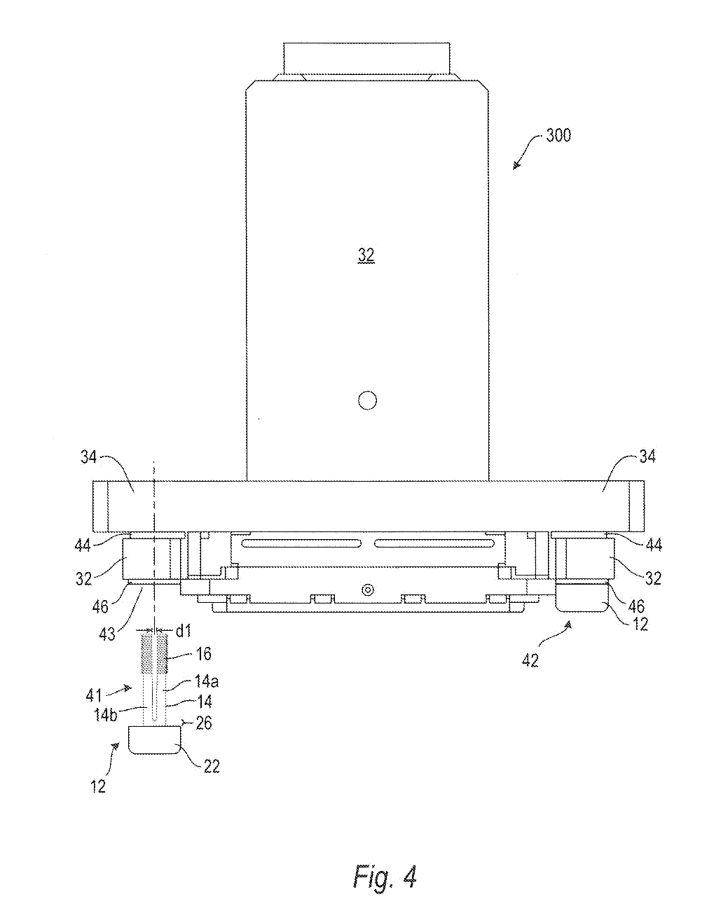

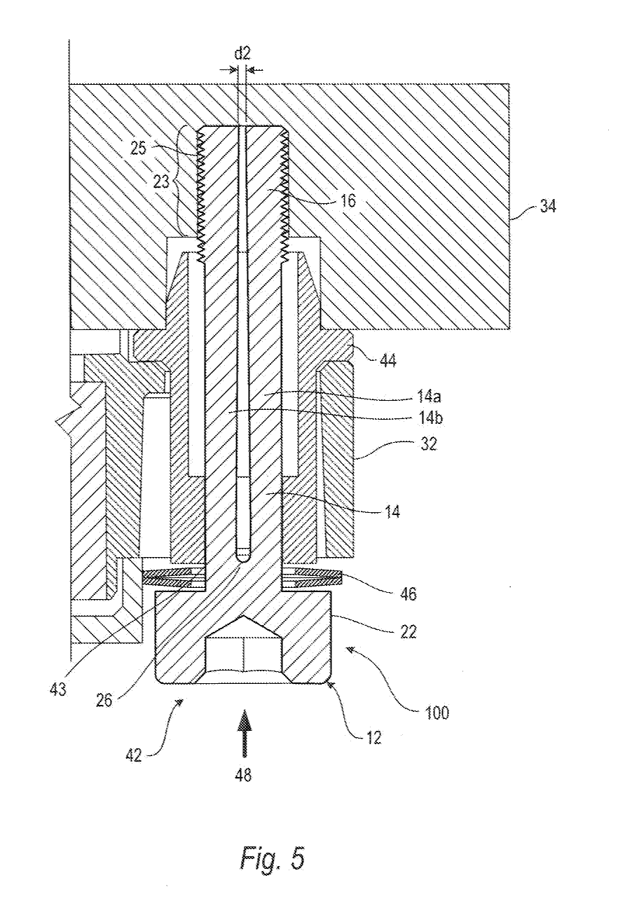

FIG. 1 illustrates a block diagram of a fastening apparatus 100 according to an example. The fastening apparatus 100 is useable with a receiving member including a receiving threaded portion. The fastening apparatus includes a fastener body 12, a plurality of deflection members 14, and a deflection threaded portion 16 on each of the plurality of deflection members 14. The fastener body 12 including a plurality of deflection members 14 spaced apart from each other. The fastener body 12 is positioned in an initial state corresponding to the plurality of deflection members 14 spaced apart from each other by a first distance (FIGS. 2 and 4) and a deflection state corresponding to the plurality of deflection members 14 spaced apart from each other by a second distance that is less than the first distance (FIG. 5). Each of the plurality of deflection members 14 include a deflection threaded portion 16 to engage with the receiving threaded portion of the receiving member in an engagement state (FIG. 5). The fastener body 12 moves to form the engagement state by moving each deflection threaded portion 16 into the receiving threaded portion such that the deflection threaded portions 16 move between the initial state and the deflection state during insertion.

FIG. 2 illustrates a schematic diagram of a fastening apparatus 100 according to an example. The fastening apparatus 100 includes the fastener body 12 with the plurality of deflection members 14, a head 22, and a transition portion 26 disposed between the plurality of deflection members 14 and the head 22. The plurality of deflection members 14, are illustrated as two deflection members 14a, 14b that are spaced apart 24 from each other such that the deflection members 14 may deflect inward in a deflection state. The fastener body 12 is useable with a receiving member 21. The receiving member 21 may include a receiving region 23 with a receiving threaded portion 25. The receiving region 23 may receive the fastener body 12.

The fastener body 12 is illustrated in the initial state with the two deflection members 14a, 14b separated by a first distance, d1. The two deflection members 14a, 14b may move from the initial state, where the deflection members 14a, 14b are spaced apart by a first distance, d1, to a deflection state, where the deflection members 14 are spaced apart by a second distance that is less than the first distance. Upon insertion, the fastener body may then enter an engagement state, where the deflection threaded portion 16 of each of the deflection members 14 engage with the receiving threaded portion 25 of the receiving member 21. Moreover, the distance between the two deflection members 14a, 14b may vary during insertion. For example, the two deflection members 14a, 14b move back and forth between the initial state and the deflection state during insertion such that the second distance moves back and forth between a range of values.

The two deflection members 14a, 14b may then lock into place in the engagement state. In the engagement state the fastener body 12 is coupled to the receiving member 21 with the deflection threaded portions 16 and the receiving threaded portion 25 engaged. For example, the engagement state may occur when each of the deflection threaded portions 16 are engaged with the receiving threaded portion 25 and/or when a portion of the deflection threaded portions 16 and receiving threaded portion 25 are engaged such that the fastener body 12 and receiving member 21 are coupled. The ratio between the diameter of the deflection members 14a, 14b separated by a first distance, d1, and a second distance less than d1 defines the strength of the deflection members 14 a, 14b; and hence, defines the load needed to insert the fastening apparatus 100. Moreover, the diameter of the deflection threaded portions 16 and the receiving threaded portion 25 may be adjusted to define the required torque to release the fastener member 12.

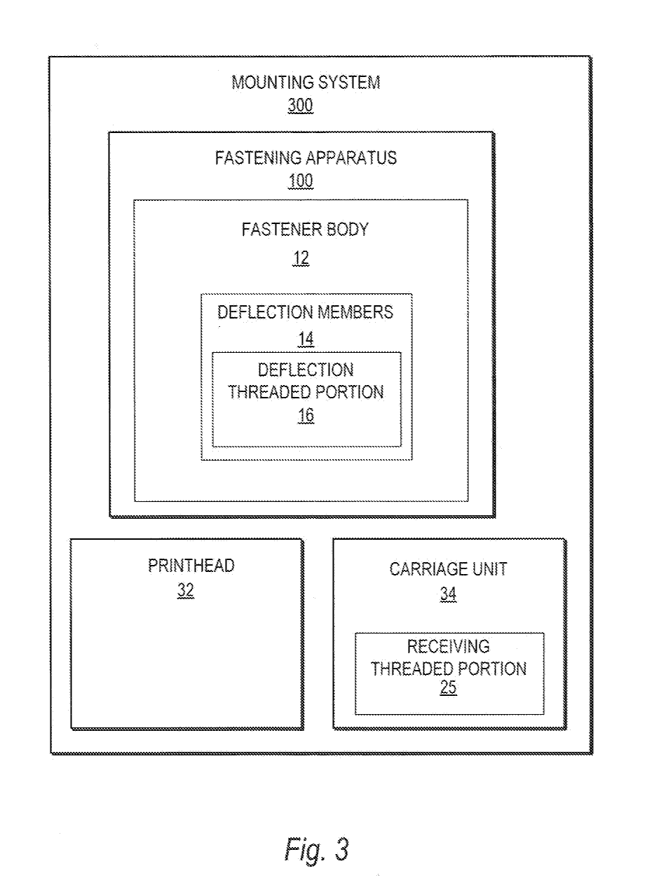

FIG. 3 illustrates a block diagram of a mounting system 300 according to an example. The mounting system 300 is useable with an image forming apparatus. The mounting system 300 includes a printhead 32, a carriage unit 34 to receive the printhead 32, and a fastening apparatus 100 to couple the printhead 32 and the carriage unit 34. The fastening apparatus 100 includes a fastener body 12 having a plurality of deflection members 14 spaced apart from each other. Each of the plurality of deflection members 14 include a deflection threaded portion 16 to engage with a receiving threaded portion 25 of the carriage unit 34.

FIG. 4 illustrates a schematic diagram of a mounting system 300 according to an example. The mounting system 300 includes the printhead 32, the carriage unit 34 to receive the printhead 32, and the fastening apparatus 100. The printhead 32 may be, for example, an inkjet printhead with a matrix of inkjet nozzles. The printhead 32 may include at least one receiving aperture to receive the fastening apparatus 100. For example, the printhead 32 may include two receiving apertures 43 on opposite sides of the printhead 32, and each of the receiving apertures 43 may receive a fastener body 12 that couples the printhead 32 and the carriage unit 34.

The carriage unit 34 may hold at least one printhead 32 and in many cases a plurality of printheads 32. The carriage unit 34 includes a receiving region 23 to receive the fastener body 12. The receiving region 23 includes the receiving threaded portion 25 to receive the plurality of deflection members 14, including the deflection threaded portions 16. The fastening apparatus 100 illustrated in FIG. 4 includes a fastener body 12 with two deflection members 14a, 14b, a head 22, and a transition portion 26 disposed between the two deflection members 14a, 14b and the head 22. The two deflection members 14a, 14b are illustrated in an initial state 41 corresponding to the two deflection members 14a, 14b spaced apart from each other by a first distance, d1 on one side of the printhead 32 and in an engagement state 42 on the opposite side of the printhead 32 with the deflection members 14 not visible.

The mounting system 300 may also include a registration pin 44. The registration pin 44 may include a cylindrical outer diameter that is conically shaped to receive the fastener body 12. The registration pin 44 is insertable into a receiving region 23 to support the fastener body 12 as the fastener body 12 is inserted into the carriage unit 34. For example, the registration pin 44 may assist in reducing lateral movement of the fastener body 12, while accounting for thermal expansion and/or contraction due to temperature changes.

The mounting system 300 may further include a spring 46. The spring 46 is illustrated as disposed on and around the fastener body 12. When the fastener body 12 is in the engagement state 42, the spring 46 engages the head 22 of the fastener body 12 and the printhead 32 to enable compression of the spring 46 without displacement of the printhead 32. The spring may be, for example, a disc spring removably disposed onto the fastener body 12. The transition portion 26 of the fastener body 12 may be threaded such that a threaded connection is formed between the spring 46 and the fastener body 12.

FIG. 5 illustrates a cross-sectional view of Section A of FIG. 4. Referring to FIG. 5, the fastening apparatus 100 is inserted through the printhead 32 and into a receiving region 23 of the carriage unit 34 such that the fastener body 12 is in an engagement state 42. In the engagement state 42, the two deflection members 14a, 14b are deflected inward such that the two deflection members 14a, 14b being spaced apart from each other by a second distance, d2, that is less than the first distance, d1, of the initial state 41. To position the second distance, d2, less than the first distance, d1, of the initial state 41, the fastener body 12 may be formed such that the receiving region 23 or a portion of the receiving region 23 has a circumference less than the circumference of the fastener body 12 in the initial state, to cause inward deflection of the two deflection members 14a, 14b during engagement. For example, the circumferences may differ by fifty to one hundred micrometers such that, in the engagement state, the fastener body 12 is held at a steady state where the second distance, d2, is less than the first distance, d1.

The mounting system 300 goes from the initial state 41, illustrated in FIG. 4 to the engagement state 42, illustrated in FIG. 5, by applying a force through the longitudinal axis of the fastener body 12, with for example, a small plunger hammer. A force 48 on the head 22 of the fastening apparatus 100 pushes the plurality of deflection members 14 towards the receiving region 23 of the carriage 34. The force 48 inserts the fastener body 12 through the printhead 32 and into the carriage unit 34. The force 48 to insert the fastener body 12 is opposed by a force, F, perpendicular to the longitudinal axis of the fastener body 12. The opposing force, F, is received from the receiving threaded portion 25 of the carriage unit 34. The opposing forces, 48 and F, cause friction between the two deflection members 14a, 14b and the receiving threaded portion 25 that moves the two deflection members 14a, 14b inward during insertion. The inward deflection enables the fastener body 12 to be inserted in the carriage unit 34 without application of torque to the printhead 32.

Specifically, the two deflection members 14a, 14b are inserted through the aperture 43 in the printhead 32 and into the receiving region 23 of the carriage unit 34. The registration pin 44 may already be inserted through the aperture 43 and into the carriage unit 34. As the two deflection members 14a, 14b are inserted the fastener body 12 moves from the initial state 41 corresponding to the two deflectable members 14a, 14b spaced apart from each other by a first distance, d1, to a deflection state corresponding to the two deflectable members 14a, 14b spaced apart from the each other by a second distance, d2. The two deflection members 14a, 14b may move between the initial and deflection state one or more times and each time the fastener body 12 is in the deflection state the two deflection members 14a, 14b may be deflected inward a different distance such that the second distance, d2, may refer to multiple second distances. However, each of the second distances, d2, are less than the first distance, d1, in the initial state 41.

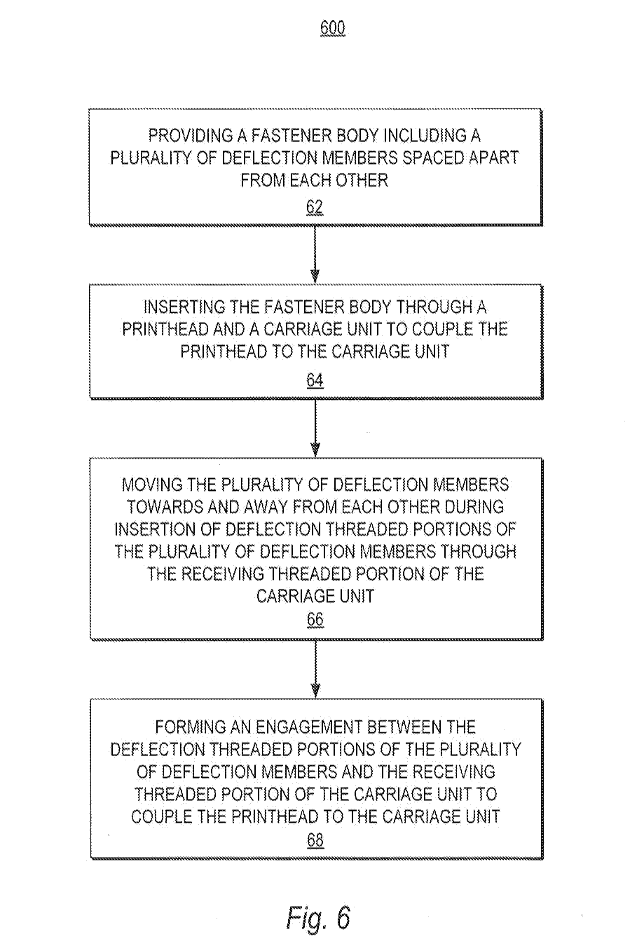

When the fastener body 12 is inserted into the carriage unit 34, the longitudinal force 48 is removed. The deflection threaded portion 16 of each of the deflection members 14a, 14b engage with the receiving threaded portion 25 to form the engagement state. In the engagement state 42, the two deflection members 14a, 14b are deflected inward in a deflected state such that the difference between the second distance, d2, and the first distance, d1, may be smaller in the engagement state 42 than in the deflection state. The fastener body 12 includes the deflection members 14a, 14b that provide a tight fit for the deflection threaded portions 16 and receiving threaded portion 25 to provide continuous contact therebetween. This arrangement may increase the torque required to release the fastening member 100 and reduce the chance of spontaneous release of the fastening member 100. Furthermore, in the engagement state, the two deflection members 14a, 14b may be inserted into the carriage unit 34, such that the deflection threaded portions 16 of the two deflection members 14a, 14b extend into one side of the carriage unit 34, but do not extend through the opposite side of carriage unit 34. FIG. 6 illustrates a flow chart 600 of a method to mount a printhead according to an example. In block 62 a fastener body is provided that includes a plurality of deflection members spaced apart from each other such that each of the plurality of deflection members having a deflection threaded portion. The fastener body is inserted through a printhead and a carriage unit to couple the printhead to the carriage unit in block 64. During insertion of the deflection threaded portions of the plurality of deflection members through the receiving threaded portion of the carriage unit, the plurality of deflection members are moved towards and way from each other in block 66. An engagement is made in block 68 between the deflection threaded portions of the plurality of deflection members and the receiving threaded portion of the carriage unit to couple the printhead to the carriage unit.

The method may also include a registration pin inserted through a receiving region of the carriage unit, for example, prior to insertion of the deflection threaded portions of the plurality of deflection members. The registration pin may support the fastener body as it enters the receiving region, which includes the receiving threaded portion. The method may further include insertion of the fastener body through, for example, application of a force through the longitudinal axis of the fastener body such that the force moves the fastener body longitudinally. Friction from the receiving threaded portion of the carriage unit provides opposing forces that cause the plurality of deflection members to deflect inward. Insertion using the method with the fastening apparatus enables insertion of the fastener body without the application of torque to the printhead. Using the method and fastening apparatus 100, the fastener body may be inserted without the use of a larger tool, such as a torque wrench, and allows for use of a smaller tool, such as a small plunger hammer that will press on the head of the bolt. Moreover, the fastening time can also be reduced since insertion with the plunger hammer takes a small amount of time, for example, one second. Furthermore, the printhead 32 may be coupled to the carriage unit with a lower vertical load from, for example, a vertical force.

The method may further include a spring connection formed between the fastener body and the printhead such that a spring compresses without displacing the printhead. The spring provides additional pressure to the fastener body to hold the body in place and prevent movement between the printhead and the carriage unit during, for example, printing. Furthermore, the combination of the registration pin and spring also allow the mounting system to remain in place and reduce lateral movement of the fastener body 12 during change in thermal conditions, which may cause expansion and/or contraction of the fastener body, printhead, and/or the carriage unit.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be exemplary. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A fastening apparatus useable with a receiving member including a receiving threaded portion, the fastening apparatus comprising:
a fastener body including a plurality of deflection members spaced apart from each other, the fastener body including an initial state corresponding to the plurality of deflection members spaced apart from each other by a first distance and a deflection state corresponding to the plurality of deflection members spaced apart from each other by a second distance less than the first distance,
each of the plurality of deflection members including a deflection threaded portion to engage with the receiving threaded portion of the receiving member in an engagement state,
wherein the fastener body moves between the initial state and the deflection state during insertion of the deflection threaded portions into the receiving threaded portion to form the engagement state.

2. The fastening apparatus of claim 1, further comprising a receiving member having a receiving region that includes the receiving threaded portion, the receiving region to receive the fastener body.

3. The fastening apparatus of claim 2, further comprising a registration pin having a cylindrical outer diameter, the registration pin insertable into the receiving region to support the fastener body during insertion into the receiving member.

4. The fastening apparatus of claim 1, wherein the fastener body further comprises a head and a transition portion disposed between the head and the plurality of deflectable members.

5. The fastening apparatus of claim 1, wherein the plurality of deflection members are deflected inward in the engagement state.

6. The fastening apparatus of claim 1, wherein the plurality of deflection members include two deflection members.

7. A mounting system useable with an image forming apparatus, the mounting system comprising:
a printhead;
a carriage unit to receive the printhead, the carriage unit including a receiving threaded portion; and
a fastening apparatus to couple the printhead to the carriage unit, the fastening apparatus including:
a fastener body including a plurality of deflection members spaced apart from each other, the fastener body including an initial state corresponding to the plurality of deflection members spaced apart from each other by a first distance and a deflection state corresponding to the plurality of deflection members spaced apart from each other by a second distance less than the first distance;
each of the plurality of deflection members including a deflection threaded portion to engage with the receiving threaded portion of the receiving member in an engagement state, such that the fastener body moves between the initial state and the deflection state during insertion of the deflection threaded portions into the receiving threaded portion to form the engagement state.

8. The mounting system of claim 7, wherein the carriage unit further comprises a receiving region that includes the receiving threaded portion to receive the fastener body.

9. The mounting system of claim 8, further comprising a registration pin having a cylindrical outer diameter, the registration pin insertable into the receiving region to support the fastener body during insertion into the carriage unit.

10. The mounting system of claim 7, wherein the fastener body further comprises a head and a transition portion disposed between the head and the plurality of deflectable members.

11. The mounting system of claim 10, further comprising a spring disposed on the fastener body, wherein the spring engages the head and the printhead to secure the fastening member in the engagement state.

12. The mounting system of claim 7, wherein the plurality of deflection members are deflected inward in the engagement state.

13. The mounting system of claim 7, wherein the plurality of deflection members include two deflection members.

14. The mounting system of claim 7, wherein in the engagement state the deflection threaded portions extend into, but not through the carriage unit.

15. The mounting system of claim 7, wherein the fastener body is insertable using a force through the longitudinal axis of the fastener body and friction from an axis perpendicular to the longitudinal axis.

16. A method to mount a printhead to a carriage unit, the method comprising
providing a fastener body including a plurality of deflection members spaced apart from each other, each of the plurality of deflection members having a deflection threaded portion;
inserting the fastener body through a printhead and a carriage unit to couple the printhead to the carriage unit;
moving the plurality of deflection members towards and away from each other during insertion of the deflection threaded portions of the plurality of deflection members through the receiving threaded portion of the carriage unit; and
forming an engagement between the deflection threaded portions of the plurality of deflection members and the receiving threaded portion of the carriage unit to couple the printhead to the carriage unit.

17. The method of claim 14, further comprising applying a force through the longitudinal axis of the fastener body during insertion of the deflection threaded portions of the plurality of deflection members such that friction from the receiving threaded portions push the plurality of deflection members inward.

18. The method of claim 14, further comprising inserting a registration pin through a receiving region of the carriage unit such that the receiving region includes the receiving threaded portion and the registration pin supports the fastener body during insertion into the carriage unit.

19. The method of claim 14, further comprising forming a spring connection between the fastener body and the printhead with a spring such that the spring compresses without displacing the printhead.

20. The method of claim 14, further comprising inserting the fastener body without applying torque to the printhead.
